(19) United States
(12) Patent Application Publication
(10) Pub. No.: US 2023/0084957 A1
(43) Pub. Date: Mar. 16, 2023

(54) OPTICAL DISTANCE MEASUREMENT DEVICE

(71) Applicant: DENSO CORPORATION, Kariya-city (JP)

(72) Inventor: Naoki FUJII, Kariya-city (JP)

(21) Appl. No.: 18/056,548

(22) Filed: Nov. 17, 2022

Related U.S. Application Data
(63) Continuation of application No. PCT/JP2021/018227, filed on May 13, 2021.

(30) Foreign Application Priority Data
May 18, 2020 (JP) 2020-086456

(51) Int. Cl. G01S 17/931

(52) U.S. Cl. CPC G01S 17/931

(57) ABSTRACT

An optical distance measurement device for a vehicle includes a sensor unit that is capable of measuring a distance to an object present in a predetermined detection region, the detection region including a first area for detecting a distance to an unknown object and one or more second area for detecting a distance to a known reference object, a storage unit that stores a reference distance, which is a previously measured distance to the reference object, and an output unit that performs predetermined output if the distance to the reference object detected in the second area by the sensor unit differs from the reference distance.

### CROSS-REFERENCE TO RELATED APPLICATION

The present application is based on and claims the benefit of priority from earlier Japanese Patent Application No. 2020-086456 filed on May 18, 2020, the description of which is incorporated herein by reference.

### BACKGROUND

### Technical Field

The present disclosure relates to an optical distance measurement device.

### Related Art

Vehicles to which an optical distance measurement device is mounted are known.

### SUMMARY

An aspect of the present disclosure is an optical distance measurement device for a vehicle. The device is capable of being mounted to the vehicle in a plurality of orientations. The device includes: a sensor unit that is capable of measuring a distance to an object present in a predetermined detection region, the detection region including a first area for detecting a distance to an unknown object and one or more second area for detecting a distance to a known reference object, which is part of the vehicle; a storage unit that stores a reference distance, which is a distance to the reference object and is measured when the optical distance measurement device is used for the first time after the optical distance measurement device is mounted to the vehicle; and an output unit that performs predetermined output if the distance to the reference object detected in the second area by the sensor unit differs from the reference distance. The second area is in an area surrounding the first area in the detection region.

### BRIEF DESCRIPTION OF THE DRAWINGS

In the accompanying drawings:

FIG. 1 is an explanatory diagram illustrating a schematic configuration of an optical distance measurement device;

FIG. 2 is an explanatory diagram illustrating an example of a detection region;

FIG. 3 is an explanatory diagram illustrating an example of a distance measurement object;

FIG. 4 is a flowchart illustrating an example of an abnormality output process;

FIG. 5 is an explanatory diagram of a detection region according to another embodiment;

FIG. 6 is an explanatory diagram of a detection region according to another embodiment;

FIG. 7 is an explanatory diagram of a detection region according to another embodiment; and

FIG. 8 is an explanatory diagram of a detection region according to another embodiment.

### DETAILED DESCRIPTION OF THE PREFERRED EMBODIMENTS

Vehicles to which an optical distance measurement device is mounted are known. JP-T-2019-507326 discloses a vehicle to which a LiDAR sensor is mounted.

The optical distance measurement device uses travel time of light reflected from an object to calculate a distance to the object. Hence, if an abnormality occurs in time measurement or distance calculation, the result of the distance measurement becomes inaccurate. When the optical distance measurement device is used in a vehicle, which is a movable body, the distance to a measurement object such as an obstacle and a movable body around the vehicle changes with time. In this case, it is difficult to detect an error of the result of the distance measurement of the optical distance measurement device by a device, which performs processing using the result of the distance measurement, without comparison with, for example, the result of distance measurement of another distance measurement device. Hence, an optical distance measurement device that can detect an abnormality thereof is desired.

### A. First embodiment:

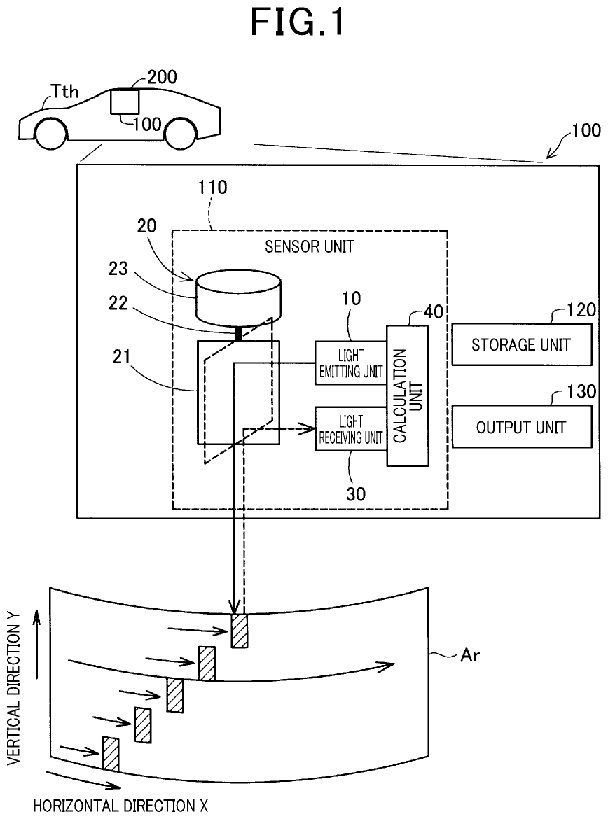

As illustrated in FIG. 1, a vehicle 200 includes an optical distance measurement device 100. The optical distance measurement device 100 optically measures a distance to an object. The optical distance measurement device 100 is, for example, a LiDAR (Light Detection and Ranging) mounted to a vehicle such as an automobile. The optical distance measurement device 100 includes a sensor unit 110, a storage unit 120, and an output unit 130.

The sensor unit 110 can measure a distance to an object present in a predetermined detection region Ar. More specifically, the sensor unit 110 emits light to an object and receives reflected light to measure the distance. The sensor unit 110 includes a light emitting unit 10 that emits laser light as pulsed light, a scanning unit 20 that scans the detection region Ar with laser light, a light receiving unit 30 for receiving incident light including reflected light from the object and disturbance light, and a calculation unit 40 that processes a signal acquired by receiving the incident light.

The light emitting unit 10, which is a light source, emits laser light for measuring a distance. For example, the light emitting unit 10 includes a laser element, a circuit board in which a drive circuit for the laser element is incorporated, and a collimating lens that converts the laser light emitted from the laser element to parallel light. The laser element is a laser diode that can oscillate a so-called short pulse laser.

The light emitting unit 10 arranges a plurality of laser diodes in the vertical direction to form a rectangular laser emission region.

The scanning unit 20 is configured by a so-called one-dimensional scanner. The scanning unit 20 is configured by a mirror 21, a rotary solenoid 23, and a rotor 22. The mirror 21 reflects the laser light which has been converted to parallel light by the light emitting unit 10. The rotary solenoid 23 receives a control signal from the calculation unit 40 and repeatedly rotates in forward and backward directions within a predetermined angular range. The rotor 22 is driven by the rotary solenoid 23 and repeatedly rotates in forward and reverse directions with a rotary shaft whose axial direction is the vertical direction to perform scanning with the mirror 21 in one direction along the horizontal direction. Incident laser light from the light emitting unit 10 is reflected by the mirror 21. The mirror 21 rotates to perform scanning with the reflected laser light along the horizontal direction. With omission of the scanning unit 20, the light emitting unit 10 may emit pulsed light into the whole detection region Ar, and the light receiving unit 30 may receive reflected light from the whole detection region Ar.

The detection region Ar corresponds to a scanning region of irradiation light of the light emitting unit 10. Since received light intensity can be acquired at each pixel position in the detection region Ar, the distribution of received light intensity in the detection region Ar forms a kind of rectangular image. When the vehicle is traveling on a horizontal road surface, the lateral direction of the detection region Ar agrees with the horizontal direction X, and the longitudinal direction agrees with the vertical direction Y. The detection region Ar will be described later in detail.

The light receiving unit 30 receives incident light including reflected light that is irradiation light that has reflected and returned from an object present in the scanning region and disturbance light. The laser light output from the light emitting unit 10 is diffused from a surface of an object such as a person and a vehicle, and part of the laser light returns to the mirror of the scanning unit 20 as reflected light. The reflected light is reflected by the mirror 21 and enters a light receiving lens of the light receiving unit 30 together with disturbance light as incident light. Then, the reflected light is collected by the light receiving lens and enters a light receiving array. The light receiving unit 30 sequentially outputs pulse signals generated due to the light reception to the calculation unit 40.

The calculation unit 40 uses travel time of light reflected from the object and received by the light receiving unit 30 to calculate a distance to the object.

The storage unit 120 stores a reference distance, which is a previously measured distance, to a reference object Tth. The reference object Tth is an object whose distance to the optical distance measurement device 100 is fixed even when the vehicle 200 is traveling. In the present embodiment, the reference object Tth is a hood. Instead of this, as the reference object Tth, part of the vehicle 200 such as a door, an antenna mounted to the vehicle 200, or the like can be employed. For example, after the optical distance measurement device 100 is mounted to the vehicle 200, the storage unit 120 stores, as the reference distance, a distance to the reference object Tth measured when the optical distance measurement device 100 is used for the first time.

If the distance to the reference object measured by the calculation unit 40 (hereinafter, also referred to as a determination distance) differs from the reference distance, the output unit 130 performs predetermined output. The predetermined output is, for example, outputting information on an abnormality of the optical distance measurement device 100 to a device that notifies the driver of the vehicle 200 or outputting information including the determination distance and the reference distance to a device performing a process using a result of distance measurement by the optical distance measurement device 100. The device performing a process using a result of distance measurement by the optical distance measurement device 100 receives the output and can, for example, determine an abnormality of the optical distance measurement device 100 itself or correct the determination distance.

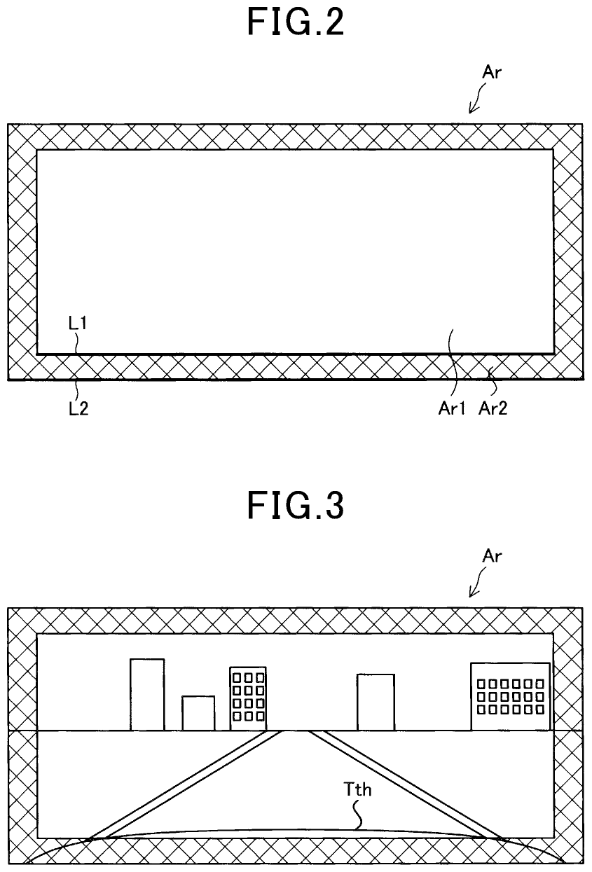

The detection region Ar illustrated in FIG. 2 includes a first area Ar1 and a hatched second area Ar2. The first area Ar1 is an area for detecting a distance to an unknown object. The second area Ar2 is an area for detecting a distance to a known reference object present in the detection region Ar. In the present embodiment, the first area Ar1 has a rectangular shape. A first side L1, which is one side forming an outer shape of the first area Ar1, is parallel to a second side L2, which is one side forming an outer shape of the detection region Ar. The second area Ar2 surrounds the first area Ar1 in the detection region Ar. The second area Ar2 includes an area between the first side L1 and the second side L2.

As illustrated in FIG. 3, the optical distance measurement device 100 is mounted to the vehicle 200 so that the reference object Tth is included in the second area Ar2.

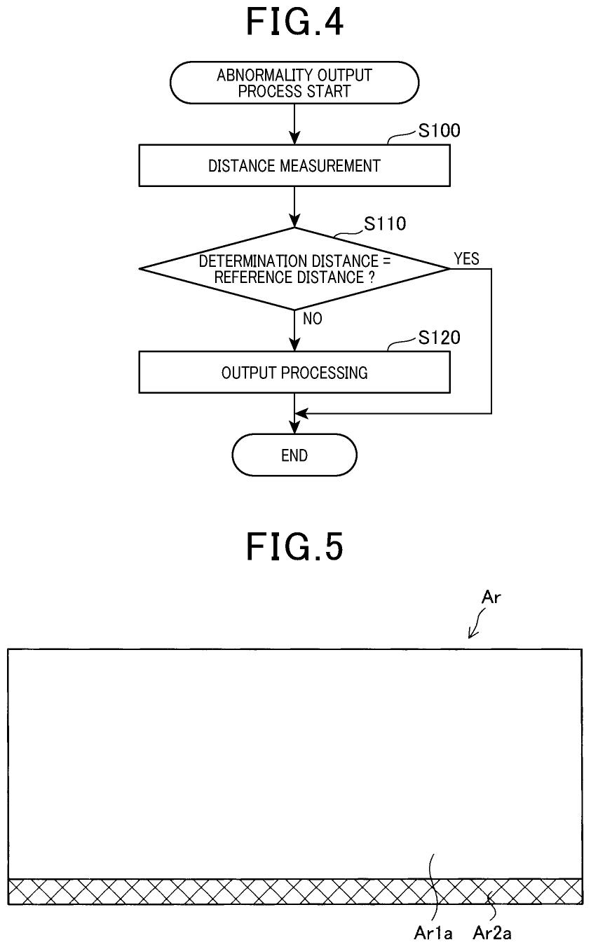

An abnormality output process illustrated in FIG. 4 is sequential processing performing the predetermined output when the optical distance measurement device 100 has an abnormality. The abnormality indicates a state in which the optical distance measurement device 100 cannot correctly perform distance measurement. More specifically, in this state, distance measurement in the detection region Ar results in an erroneous value. For example, a light receiving circuit of the light receiving unit 30 cannot correctly perform time measurement until reflected light is received. This process is performed when the optical distance measurement device 100 performs distance measurement.

In step S100, the sensor unit 110 performs distance measurement. More specifically, the calculation unit 40 performs distance measurement by using travel time of reflected light received by the light receiving unit 30.

In step S110, the output unit 130 determines whether the distance to the reference object measured by the sensor unit 110 in step S100 is equal to the reference distance. When the determination distance is equal to the reference distance, the optical distance measurement device 100 completes the abnormality output process. In contrast, if the determination distance is not equal to the reference distance, the process proceeds to step S120, in which the output unit 130 performs the predetermined output in output processing.

According to the optical distance measurement device 100 of the present embodiment described above, the output unit 130 performs the predetermined output when the distance to the known reference object Tth, which is present in the predetermined detection region Ar, measured by the optical distance measurement device 100 differs from the reference distance, which is the previously measured distance to the reference object Tth. Hence, the optical distance measurement device 100 can detect an abnormality thereof. In addition, for example, without complicated processing such as measurement of travel time of light and comparison of details of calculation or the like, which is a process for calculating a distance to an object by the calculation unit 40, the optical distance measurement device 100 can detect an abnormality thereof.

In addition, the second area Ar2 surrounds the first area Ar1 of the detection region Ar. That is, the second area Ar2 for detecting a distance to a known reference object present in the detection region Ar is on the outer periphery of the first area Ar1 for detecting a distance to an unknown object. Hence, the optical distance measurement device 100 can measure a distance to the reference object without interrupting a distance measurement function of the first area Ar1. In addition, a distance to the reference object can be detected regardless of the installation location and the orientation of the optical distance measurement device 100 and the installation location of the sensor unit 110 in the optical distance measurement device 100.

### B. Other embodiments:

(B1) In the above embodiment, the detection region Ar and the first area Ar1 have a rectangular shape. Instead of this, the detection region Ar and the first area Ar1 may have a triangular shape, a pentagonal shape, or a circular shape.

(B2) In the above embodiment, the second area Ar2 surrounds the first area Ar1 in the detection region Ar. Instead of this, as illustrated in FIG. 5, a second area Ar2 may not surround a first area Aria in the detection region Ar.

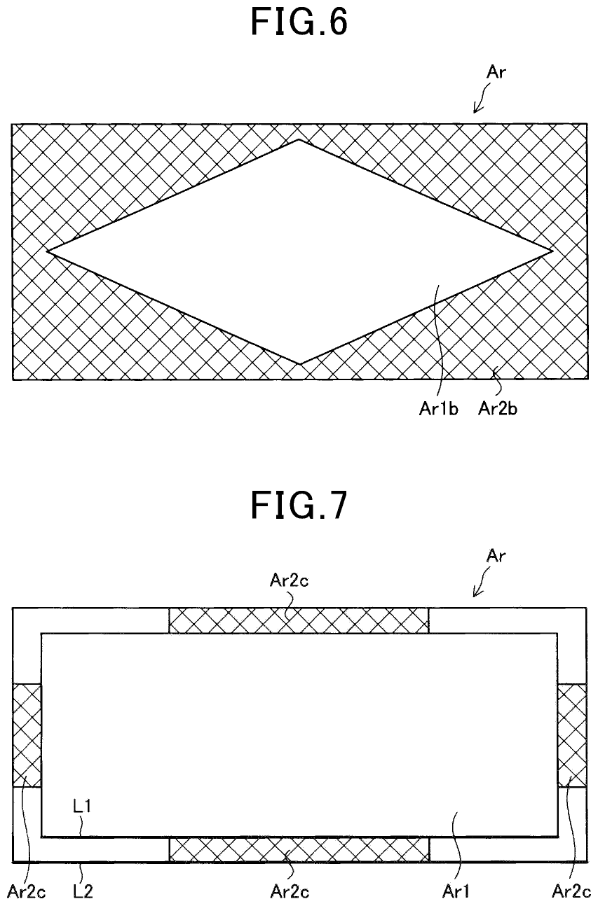

(B3) In the above embodiment, the first side L1, which is one side forming an outer shape of the first area Ar1, is parallel to a second side L2, which is one side forming an outer shape of the detection region Ar. Instead of this, as illustrated in FIG. 6, the first area Ar1b may not have the side parallel to one side forming the outer shape of the detection region Ar. As illustrated in FIG. 6, the second area Ar2b may be in an area surrounding the first area Ar1b in the detection region Ar.

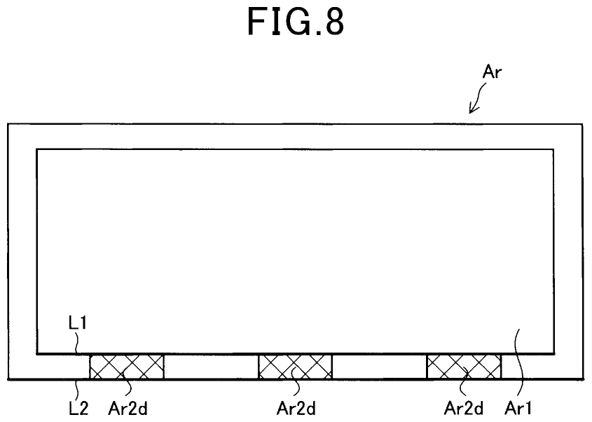

(B4) In the above embodiment, the second area Ar2 surrounds the first area Ar1 in the detection region Ar. Instead of this, as illustrated in FIG. 7, at least one second area Ar2c may be present in an area surrounding the first area Ar1 of the detection region Ar. As illustrated in FIG. 8, one or more, for example, three or four second areas Ar2d may be present in an area between the first side L1 and the second side L2.

The present disclosure is not limited to the above embodiments and can be implemented by various configurations within a range not deviating from the spirit thereof. For example, technical features in the embodiments corresponding to the technical features in the aspect described in SUMMARY can be appropriately replaced or combined with each other in order to solve the problems described above or to achieve all or part of the effects described above. Some of the technical features can be appropriately deleted if they are not described as essentials herein.

According to the embodiment of the present disclosure, an optical distance measurement device (100) for a vehicle (200) is provided. The optical distance measurement device is capable of being mounted to the vehicle in a plurality of orientations, and includes a sensor unit (110) that is capable of measuring a distance to an object present in a predetermined detection region, the detection region including a first area for detecting a distance to an unknown object and one or more second area for detecting a distance to a known reference object, which is part of the vehicle; a storage unit (120) that stores a reference distance, which is a distance to the reference object and is measured when the optical distance measurement device is used for the first time after the optical distance measurement device is mounted to the vehicle; and an output unit (130) that performs predetermined output if the distance to the reference object detected in the second area by the sensor unit differs from the reference distance. The second area is in an area surrounding the first area in the detection region.

According to the optical distance measurement device, when a distance to a known reference object present in a predetermined detection region differs from a reference distance, which is a previously measured distance to the reference object, predetermined output is performed. Hence, the optical distance measurement device can detect an abnormality thereof.

What is claimed is:

1. An optical distance measurement device for a vehicle, the device being capable of being mounted to the vehicle in a plurality of orientations, the device comprising:
a sensor unit that is capable of measuring a distance to an object present in a predetermined detection region, the detection region including a first area for detecting a distance to an unknown object and one or more second area for detecting a distance to a known reference object, which is part of the vehicle;
a storage unit that stores a reference distance, which is a distance to the reference object and is measured when the optical distance measurement device is used for the first time after the optical distance measurement device is mounted to the vehicle; and
an output unit that performs predetermined output if the distance to the reference object detected in the second area by the sensor unit differs from the reference distance, wherein
the second area is in an area surrounding the first area in the detection region.

2. The optical distance measurement device according to claim 1, wherein
the detection region has a rectangular shape,
the first area has a rectangular shape,
a first side, which is one side forming an outer shape of the first area, is parallel to a second side, which is one side forming an outer shape of the detection region, and
one or more of the second area is in an area between the first side and the second side.
